(19) United States
(12) Patent Application Publication
(10) Pub. No.: US 2025/0247919 A1
(43) Pub. Date: Jul. 31, 2025

(54) DOWNHOLE NANO PARTICLE HEAT BLANKET FOR NEUTRON GENERATOR TUBES AND OTHER APPLICATIONS

(71) Applicant: Halliburton Energy Services, Inc., Houston, TX (US)

(72) Inventors: Imran Sharif Vehra, Houston, TX (US); Krutibas Panda, Houston, TX (US); Xuesong Ou, Houston, TX (US)

(73) Assignee: Halliburton Energy Services, Inc., Houston, TX (US)

(21) Appl. No.: 19/038,472

(22) Filed: Jan. 27, 2025

Related U.S. Application Data
(60) Provisional application No. 63/626,485, filed on Jan. 29, 2024.

(51) Int. Cl. H05B 3/34; G01V 5/10

(52) U.S. Cl. CPC H05B 3/342; G01V 5/10

(57) ABSTRACT

Methods and systems described herein may comprise a neutron generator tube; a gas replenisher; and a heat blanket applied to the neutron generator tube configured to insulate the gas replenisher. In addition, the heat blanket comprises an acrylic polymer-based elastomer. Further, the acrylic polymer-based elastomer is cross-linked with mineral fillers to form a composite material.

### CROSS REFERENCE TO RELATED APPLICATIONS

This application claims the priority of U.S. Provisional Patent Application No. 63/626,485, Filed Jan. 29, 2024, which is incorporated by reference in its entirety.

### BACKGROUND

Wellbores drilled into subterranean formations may enable recovery of desirable fluids (e.g., hydrocarbons) using a number of different techniques. During drilling operations, slickline operations, or during wireline operations, measurements may be taken to determine the presence of oil, water, gas, and/or the like. One such device that may be utilized for these measurements may be a pulsed neutron tool. The pulsed neutron tool may comprise a pulsed neutron generator (PNG) that may operate and function to transmit neutrons into a formation for either logging while drilling (LWD) or wireline logging measurements. The PNG may perform neutron pulse spectroscopy at multiple depths downhole.

Generally, a PNG may implement a neutron generator tube. In examples, a neutron generator tube may comprise a gas replenisher, which may be widely used in a downhole nuclear logging tool for oil and/or gas well measurements. The gas replenisher may only release tritium gas into the neutron generator tube when exposed to elevated temperatures. Herein elevated temperatures may range from 200-1,000° C. An example of the gasses produced may be Tritium gas within the neutron generator tube, which may allow for neutron generation.

Gas generators must be heated to elevated temperatures to produce Tritium, or other gasses. Traditionally, gas generators are heated by implementation of a downhole battery. Specifically, current may be circulated through the gas generator over a time period. The circulated current produces heat in the gas generator ranging from 200-1,000° C. The heated gas generator may then produce Tritium gas allowing for neutron generation and of a single pulse of neutron pulse spectroscopy. However, the circulating current draws a large amount of power and requires robust downhole battery and pumping implementations. Additionally, this requirement may force the neutron generation for a single pulse of neutron pulse spectroscopy implementation to not only consume high power, but also consume power during pumps off cycle. As such, there may be a design limitation for batteries requiring enough capacity to last for a full downhole pumps-off operation. There is a need to improve the performance of the gas generator.

### BRIEF DESCRIPTION OF THE DRAWINGS

These drawings illustrate certain aspects of some examples of the present disclosure and should not be used to limit or define the disclosure.

FIG. 1 illustrates a downhole tool in a wireline configuration, in accordance with examples of the present disclosure.

FIG. 2 is a diagram of illustrative embodiments of a pulsed-neutron logging tool.

FIG. 3 illustrates an alternative example of a pulsed-neutron logging tool.

FIG. 4 illustrates another alternative example of a pulsed-neutron logging tool.

FIG. 5 illustrates an example of a neutron generator tube.

FIG. 6 illustrates an acrylic polymer.

### DETAILED DESCRIPTION

The present disclosure generally relates to systems and methods for insulating at least a part of a gas generator, which may be utilized in a neutron generator tube for neutron pulse spectroscopy. As discussed below, filled polymer materials exhibiting insulation may be utilized to form a heat blanket around a gas generator. The Application of a heat blanket in pumps-off duration may reduce the design capacity for downhole batteries, improve the neutron pulse spectroscopy operation by offering more and/or longer neutron generation pulses, or reducing the size of or eliminating the need for downhole batteries. Additionally, a heat blanket may reduce the power requirement for heating during pumps-on duration. Further, heat blankets may also be applied to other components. For example, a heat blanket may be applied to rechargeable batteries for widening operating temperature range.

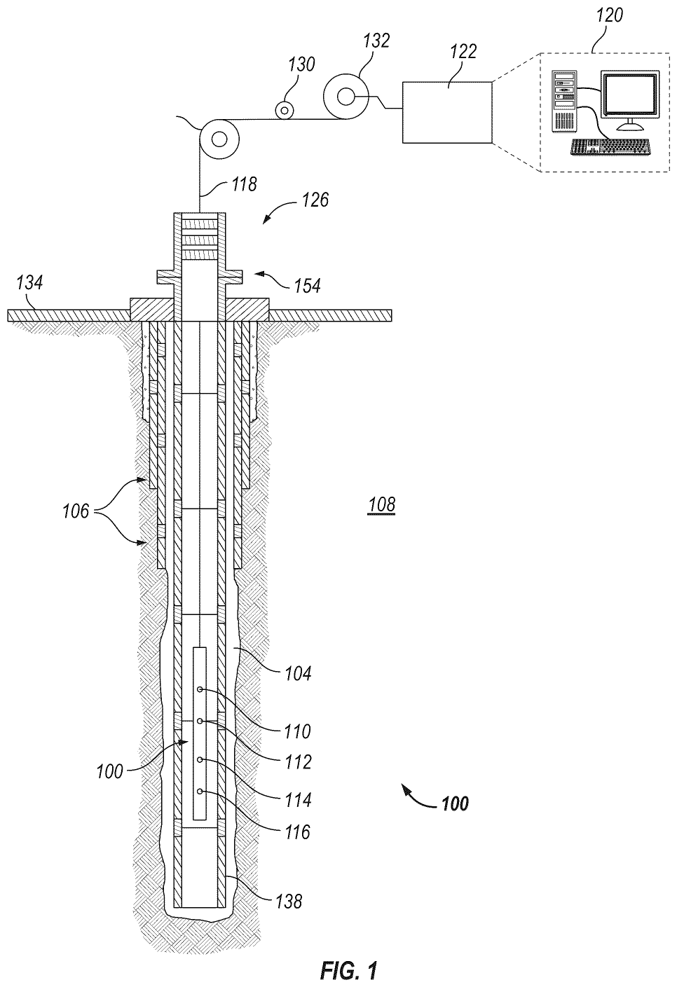

FIG. 1 illustrates logging/measuring operation 100, as disclosed herein, utilizing a pulsed-neutron logging tool 102. FIG. 1 illustrates a cross-section of borehole 104 with a pulsed-neutron logging tool 102 traveling through casing string 106. Borehole 104 may traverse through formation 108 as a vertical well and/or a horizontal well. Pulsed-neutron logging tool 102 contains a neutron generator 110, a first neutron detector 112, a second neutron detector 114, and a gamma ray detector 116. Pulsed-neutron logging tool 102 is suspended by a conveyance 118, which communicates power from a logging facility 120 to pulsed-neutron logging tool 102 and communicates telemetry from pulsed-neutron logging tool 102 to information handling system 122. In examples, pulsed-neutron logging tool 102 may be operatively coupled to a conveyance 118 (e.g., wireline, slickline, coiled tubing, pipe, downhole tractor, and/or the like) which may provide mechanical suspension, as well as electrical connectivity, for pulsed-neutron logging tool 102. Conveyance 118 and pulsed-neutron logging tool 102 may extend within casing string 106 to a depth within borehole 104. Conveyance 118, which may include one or more electrical conductors, may exit wellhead 126, may pass around pulley 128, may engage odometer 130, and may be reeled onto winch 132, which may be employed to raise and lower the tool assembly in borehole 104. Wellhead 126 allows for entry into borehole 104 and placement of pulsed-neutron logging tool 102 into pipe string 152. The position of pulsed-neutron logging tool 102 may be monitored in a number of ways, including an inertial tracker in pulsed-neutron logging tool 102 and a paid-out conveyance length monitor in logging facility 120.

Multiple such measurements may be desirable to enable the system to compensate for varying cable tension and cable stretch due to other factors. Information handling system 122 in logging facility 120 collects telemetry and position measurements and provides position-dependent logs of measurements from pulsed-neutron logging tool 102 and values that may be derived therefrom.

Pulsed-neutron logging tool 102 generally includes multiple instruments for measuring a variety of downhole parameters. Wheels, bow springs, fins, pads, or other centralizing mechanisms may be employed to keep pulsed-neutron logging tool 102 near the borehole axis during measurement operations. During measurement operations, generally, measurements may be performed as pulsed-neutron logging tool 102 is drawn up hole at a constant rate. The parameters and instruments may vary depending on the needs of the measurement operation.

Pulsed-neutron logging tool 102 operates by generating pulses of high energy neutrons that radiate from neutron generator 110 into the surrounding environment including borehole 104 and formation 108. The highly energetic neutrons entering the surrounding environment interact with atomic nuclei, inducing gamma ray radiation. Induced gamma rays and neutrons may be recorded by first neutron detector 112, second neutron detector 114, and/or gamma ray detector 116. The scattered neutrons and gamma ray spectrum may yield accurate knowledge of borehole and formation. Accurate knowledge of the borehole and formation may provide neutron pulse spectroscopy of oil and gas in the formation as well as determining the flow in production wells.

Measurements taken by pulsed-neutron logging tool 102 may be gathered and/or processed by information handling system 122. For example, signals recorded by pulsed-neutron logging tool 102 may be sent to information handling system 122 where they may be stored on memory and then processed. The processing may be performed real-time during data acquisition or after recovery of pulsed-neutron logging tool 102. Processing may alternatively occur downhole on an information handling system disposed on pulsed-neutron logging tool 102 or may occur both downhole and at surface. In some examples, signals recorded by pulsed-neutron logging tool 102 may be conducted to information handling system 122 by way of conveyance 118. Information handling system 122 may process the signals, and the information contained therein may be displayed for an operator to observe and stored for future processing and reference. Information handling system 122 may also contain an apparatus for supplying control signals and power to pulsed-neutron logging tool 102.

In logging systems, such as, for example, logging systems utilizing the pulsed-neutron logging tool 102, a digital telemetry system may be employed, wherein an electrical circuit may be used to both supply power to pulsed-neutron logging tool 102 and to transfer data between information handling system 122 and pulsed-neutron logging tool 102. A DC voltage may be provided to pulsed-neutron logging tool 102 by a power supply located above ground level, and data may be coupled to the DC power conductor by a baseband current pulse system. Alternatively, pulsed-neutron logging tool 102 may be powered by batteries located within the downhole tool assembly, and/or the data provided by pulsed-neutron logging tool 102 may be stored within the downhole tool assembly, rather than transmitted to the surface during logging.

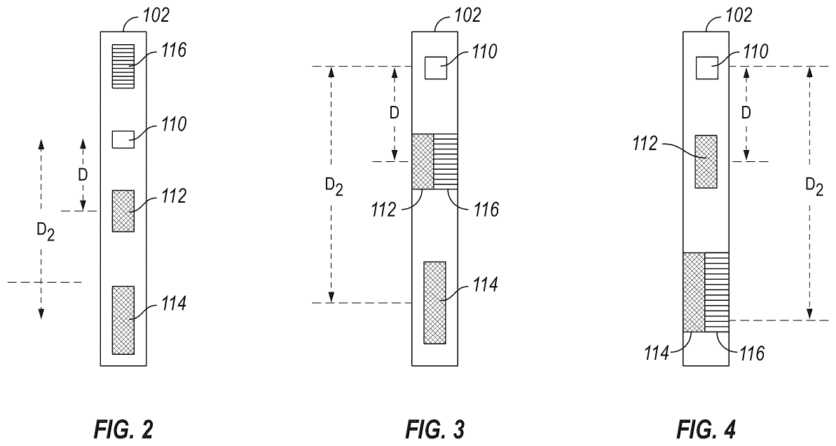

FIG. 2 shows a first illustrative setup of pulsed-neutron logging tool 102 having a pulsed neutron generator 110 that is positioned equidistant from a gamma ray detector 116 and a first neutron detector 112. In examples, pulsed neutron generator 110 may comprise a neutron generator tube, to be discussed below. Pulsed-neutron logging tool 102 may also include a second neutron detector 114. The two neutron detectors 112 and 114 may be, respectively, termed the “near” and “far” neutron detectors. “Near” being the closest neutron detector to pulsed neutron generator 110 and “far” being the furthest neutron detector from pulsed neutron generator 110. Neutron detectors 112 and 114 may be designed to count thermal (around about 0.025 eV) and/or epithermal (between about 0.1 eV and 100 eV) neutrons. Suitable neutron detectors include Helium-3 (He-3) filled proportional counters, though other neutron counters may also be used. In examples, each neutron detector 112 and/or 114 may be implemented as a bank of individual detection devices. General, neutron porosity tool measurement techniques, the ratio of far-to-near neutron detector counts is indicative of formation porosity.

With continued reference to FIG. 2 gamma ray detector 116 may be implemented as a scintillation crystal coupled to a photomultiplier tube. As with neutron detectors 112 and/or 114, gamma ray detector 116 may be implemented as a bank of individual detection devices whose results are aggregated. In FIG. 2, gamma ray detector 116 is “co-distant” with the near neutron detector 112, i.e., it is positioned at the same distance D from neutron generator 110 as near neutron detector 112. As illustrated in FIG. 2, gamma ray detector 116 and first neutron detector 112 may be located in opposite directions from neutron generator 110.

FIGS. 3 and 4 illustrate alternative embodiments of pulsed-neutron logging tool 102. FIG. 3 shows an alternative example in which pulsed-neutron logging tool 102 has a gamma ray detector 116 and a near neutron detector 112 co-located, i.e., located side-by-side at the same distance D from the neutron generator 110. FIG. 4 shows yet another alternative example in which pulsed-neutron logging tool 102 has a gamma ray detector 116 and a far neutron detector 114 co-located at a distance D₂ from neutron generator 110.

Multiple neutron detectors 112, 114 of pulsed-neutron logging tool 102, enable pulsed-neutron logging tool 102 to measure formation porosity using any of the existing multiple-spacing techniques. In addition, the presence of gamma ray detector 116 having a common distance from neutron generator 110 with one of the neutron detectors 112 or 114, enables the measurement of elemental gamma ray spectroscopy. During measurement operations, neutrons may be from neutron generator 110. Critical to neutron generator 110 is a neutron generator tube comprising a gas replenisher.

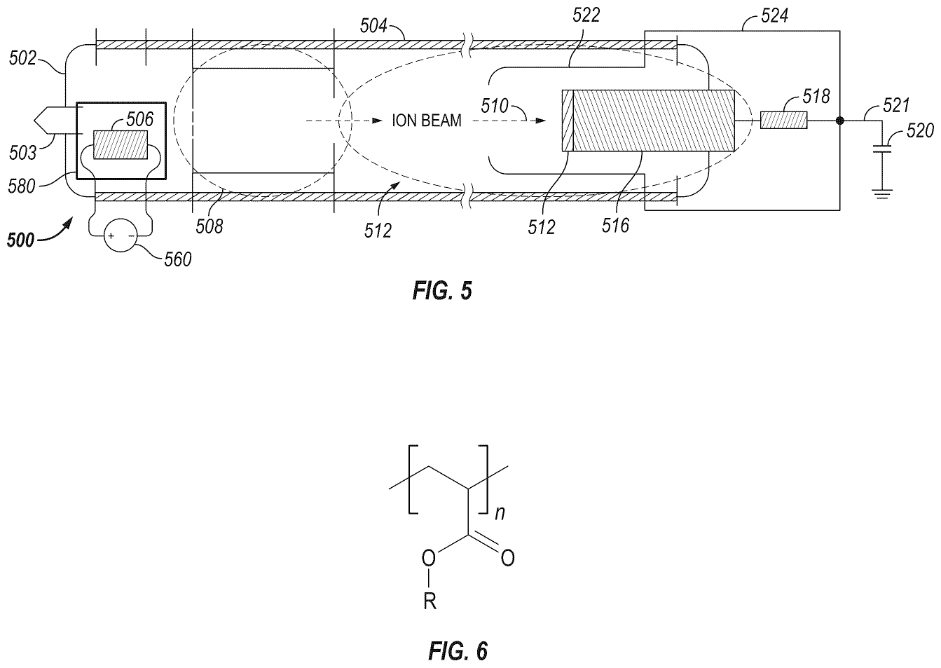

FIG. 5 illustrates a neutron generator tube 500 of neutron generator 110 (e.g., referring to FIG. 1). As illustrated, neutron generator tube 500 may comprise a vacuum housing 502, which may comprise a copper tubing 503 at the end part for vacuum processing. In examples, copper tubing 503 may be later pinched off to seal and create a sealed vacuum within neutron generator tube 500. Vacuum housing 502 may comprise insulating tube 504 for different voltage settings on different parts. In examples, insulating tube 504 may comprise glass and/or ceramic, which are materials that may provide both electrical insulation and enable the formation of a sealed vacuum during a sealing process. For example, insulating tube 504 may comprise one or more nickel-cobalt ferrous alloy washers used as electrodes and one or more ceramic housing rings as insulating spacers in a designed configuration with chosen geometry is brazed together. Within vacuum housing 502, a gas replenisher 506, which is typically porous Titanium or Zirconium metals for absorbing hydrogen gas, may be disposed for storing deuterium and tritium (D/T) gas. Generally, gas replenisher 506 may store a mixture of D₂ and T₂ gas, in a 50-50% ratio. In examples, gas replenisher 506 may be connected to a downhole power source 560. Downhole power source 560 may be a battery or other downhole power source configured to produce a circulating current in gas replenisher 506. The circulating current produces heat in the gas generator ranging from 200-1,000° C. The heated gas generator may then produce Tritium gas allowing for a single pulse of neutron pulse spectroscopy. Traditionally, the gas replenisher is then allowed to cool for another pulse. However, in examples, heat blanket 580 may be applied to gas replenisher 506 for insulation.

Heat blanket 580 may be applied to gas replenisher 506 to insulate it after a neutron generation pulse. Heat blanket 580 may be applied to gas replenisher 506 to yield insulation to gas replenisher. For example, heat blanket 580 may comprise an acrylic polymer-based elastomer filled with insulative mineral particles with dimensions at level of nanometer to micrometer, to be discussed in detail below. In examples, acrylic polymer-based elastomer may have heat resistance comparable to that of fluoride elastomers. It also has excellent damping properties under high temperature. Acrylic polymer-based elastomer comprise any polymer prepared from acrylate monomers.

FIG. 6 illustrates an acrylic polymer-based elastomer which may be used at least partially as heat blanket 580. Acrylic polymer can be elastomer or plastic. Acrylic elastomers may be thermoset. As discussed above, there may be mineral fillers disposed of between acrylic polymer-based elastomer. Herein, mineral fillers may be inflammable mineral fillers with low heat conductivity and comprise a surface to volume ratio of at least 1*10\hat{ }5 m²/m³. The dimensions of these mineral fillers may be in the scale of nanometer to micrometer level. As such, each mineral filler may range in length, height, and width of 0.01 nm-0.1 nm, 0.1 nm-10 nm, 10 nm-100 nm, 100 nm-1 mm, or larger. Smaller mineral fillers have better interactions between acrylic polymer-based elastomer. Herein, mineral fillers may be utilized to strengthen to structural integrity of acrylic polymer-based elastomer. The acrylic polymer-based elastomer itself is a good thermal insulator but lacks strength. Thus, mineral fillers may be added to the polymer to reinforce it and improve its structural integrity. These mineral fillers, due to their small-sized particles, provide a high surface area to volume ratio, which contributes to better strength and thermal performance. The mineral fillers reinforce the polymer by improving its mechanical properties. Acrylic polymer-based elastomer, in their natural state, tend to be pliable and flexible, but they are not very strong under stress. By incorporating fillers like talc or silicates, the strength of the composite material is significantly enhanced. These fillers help distribute stress more evenly across the material, making it stronger and more durable.

The mineral fillers may also contribute to enhanced heat insulation properties. Because of their small size and large surface area, they improve, by lowering, the thermal conductivity of the acrylic polymer-based elastomer in a beneficial way. While the acrylic polymer-based elastomer itself has insulating properties, the fillers improve heat resistance and thermal barrier capabilities by essentially forming a composite structure that works together to keep heat in or out, depending on the application. The combination of the acrylic polymer-based elastomer and the fillers creates a composite material, where both components work together to provide a material with improved mechanical strength and enhanced heat insulation. The nano-fillers provide the reinforcement needed to offset the acrylic polymer-based elastomer's inherent weakness, while the overall structure of the composite maintains excellent thermal insulating properties. The mineral fillers interact with the acrylic polymer-based elastomer to reinforce its structure and improve its thermal insulating properties, with the filler size, type, and concentration playing key roles in determining the material's overall performance. In examples, the mineral fillers being combined to the acrylic polymer-based elastomer may be referred to as cross-linking mineral fillers acrylic polymer-based elastomers with to form a composite material as heat blanket 580 (e.g., referring to FIG. 5). In other words, the acrylic polymer-based elastomer is cross-linked with mineral fillers to form a composite material. The cross-link of acrylic elastomer is between acrylic polymer chains. The chains may cross-link to form a 3D network. This may improve mechanical properties and stability. In addition, there may be chemical cross-link between filler particle and polymer chain. In examples, some filler may not have strong interaction with polymer chains at all. Instead, they may be rigid particles dispersed in polymer matrix. They still reinforce the elastomer.

Cross linking may be achieved by heating the acrylic polymer-based elastomer to above 300 degrees Fahrenheit for 15 to 60 minutes. Then the acrylic polymer-based elastomer may be cured with the filler material to produce a hardened material. In examples, the hardened material may comprise a hardness of 30-95 of Shore A. Further, acrylic polymer-based elastomer may be cured by Metal Stearate, Diamine or Organic Peroxide. In examples, the heating may be between 150-1,000 degrees Fahrenheit, the time period may be for 1 minute to 1,000 minutes or more, and the harness may be between 0.1-100 Shore A. With sufficient dispersion of such mineral fillers, the composite may show very high heat insulation properties as well as flame retardance. Once cured, acrylic polymer-based elastomer may be molded forming heat blanket 580 directly onto neutron generator tube 500 (e.g., referring to FIG. 5). In examples, cured acrylic polymer-based elastomer may be formed/molded into a blanket, and moved separately where it is then applied to neutron generator tube 500.

The possible mineral fillers to be added to the acrylic polymer-based elastomer may comprise, but are not limited to, Talc, Silicates, montmorillonite, calcium carbonate, kaolin, clay, and/or the like. A combination of two or more mineral filler may also be used. In examples, the dosage of mineral filler may be between 100-300 parts per hundred rubber. This means there may be 100-300 grams of mineral filler for every 100 grams of acrylic polymer-based elastomer. In addition, the range may also be 0.1-100 parts per hundred rubber, 100-1,000 parts per hundred rubber, 1,000-10,000 parts per hundred rubber, or more. In addition, processing oil and/or processing aids may be added to improve flowability before curing. To maintain inflammability and low heat conductivity, the dosage of processing oil and/or processing aids should be minimized. The dosage of such components should be kept below 10 parts per hundred rubber in total. Stabilizers may improve durability under high temp or other extreme environments. Stabilizers that may be used for such compounds include Phenolic based, Amine based, Heterocyclic based, and Phosphite based stabilizer fillers. The dosage may be kept below 20 parts per hundred rubber to avoid negative impact on other properties. In examples, Acrylic polymer itself may not have enough heat insulation. Further, Mineral fillers have much lower heat conductivity than acrylic polymer. As such, mineral fillers may be dispersed well to enhance heat insulation.

In other examples, to maintain inflammability and low heat conductivity, conductive and flammability fillers like carbon blacks should be avoided. In addition, to maintain inflammability and low heat conductivity, the dosage of processing oil and/or processing aids should be minimized. The dosage of such components should be kept below 10 PHR in total. Further, stabilizers applied to acrylic polymer-based elastomer may help to improve durability under high temp or other extreme environments. Stabilizers that can be used for such compounds include Phenolic based, Amine based, Heterocyclic based and Phosphite based etc. The dosage of a stabilizer may be kept below 20 PHR to avoid negative impact on other properties.

Acrylic polymer-based elastomer may comprise heat resistance properties comparable to that of fluoride elastomers. Additionally, acrylic polymer-based elastomer comprises excellent damping properties under high temperature. An acrylic polymer-based elastomer comprise any polymer prepared from Acrylate monomers.

Referring back to FIG. 5, the same D₂ and T₂ gas mixture may also be loaded in target film 514, which faces ion source 508. Target film 514 may be a coating disposed on a target rod 516, utilizing target rod 516 as a backing structure. Target rod 516, for example, may be Copper or other suitable metals which are good for electrical conductivity and thermal dissipation.

Target film 514 may comprise transitional metals, which may form metal hydrides to store hydrogen gas (e.g., D₂ and T₂ gas). Commonly used metals for target film 514 are Scandium, Titanium, Zirconium, or any combination of these materials in multi-layered form. These transitional metals have been widely studied for applications in neutron generator tubes 500 as both gas replenisher 506 and target film 514. As target film 514 for neutron generator tube 500, the hydrogen to metal atomic ratio inside a saturated metal may be as high as 2:1. Generally, a ratio of 1.8:1 seems to be a practical maximum, while a range of 1.6:1-1.7:1 is common. The ratio may depend at least in part on the ambient temperatures during operation. The ratio degrades at higher temperatures, and may even go down to 0:1, as Hydrogen degases from target film 514. FIG. 12 is a graph that shows residual Titanium percentage of target film 514 as a function of temperature after heating for one hour at each temperature setting. As seen in the graph, both Zirconium and Titanium start degassing at 200 degrees Celsius or higher. Scandium may improve the performance of target film 514, which starts to degas at higher temperatures than both Zirconium and Titanium.

Referring back to FIG. 5, during operations, an ion beam 510 from ion source 508 with 100 μA current may be transmitted to bombard target film 514 normally at 100 kV. Thus, there is roughly ten Watts heating power to target film 514 and target rod 516. This may elevate the body temperature of target rod 516 above ambient, often with a ΔT=80-100 degrees Celsius, which may result in degassing of D/T gas from target film 514, such as, Titanium. A decreased D/T gas concentration inside a target film 514 of Titanium may result in a reduced neutron yield for target assembly 512.

As illustrated in FIG. 5, ion source 508 for generating an ion beam 510 may be disposed within vacuum housing 502. During operations, ion source 508 may transmit one or more ion beams 510 to a target assembly 512 disposed within vacuum housing 502. In examples, target rod 516 may act as an electrical connector to HV power supply 520, and a thermal conductor to transfer any excessive heat from target assembly 512 outside of neutron generator tube 500. In this way, D₂ and T₂ molecular ions, generated from ion source 508, may be accelerated to bombard target film 514 loaded with the same gas. During bombardment, the D-T, or T-D fusion reactions occur at a given high voltage to generate neutrons. The D-D fusion reaction may have a low cross-section in a typical HV region.

Suppressor 522, which is an added metal electrode, may be utilized to suppress secondary electron emission from target film 514. As illustrated, suppressor 522 may be connected via a corona shield 524 outside vacuum housing 502 to high voltage (HV) power supply 520. Additionally, suppressor 522 may operate and function to accelerate ion beam 510 for bombarding target assembly 512, which may create a D/T fusion reaction to generate neutrons. A corona shield 524 may operate and function to smoothen an electrical field that is generated outside target assembly 512 by neutron generator tube 500. Corona shield 524 may function as the electrical connector between HV power supply 520 and suppressor 522. During an example operation, a resistor 518 that may be 2 MΩ, and an ion beam 510 of 100 μA, may produce an automatic voltage difference of 200 V between suppressor 522 and target film 514, to send back the secondary low-energy electrons. For a given HV power supply 520 of 100 kV, an ion beam 510 of 100 μA current, and a saturated target film 514 (for this example made of Titanium) at a level of 1.8-2.0 D/T atoms per Titanium atom, a neutron yield typically of 3×10⁸ n/sec may be generated. The generated neutrons may then be transmitted from neutron generator 110 as described above. In examples, reduction or elimination of downhole power source 560 may still allow for neutron pulse spectroscopy with the implementation of heat blanket 580. Additionally, heat blanket 580 may be applied to further downhole components.

It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

The methods and systems described above may allow for greater shifting forces by using hydraulic pressure rather than a magnetic coupling. The mechanical linkage is removed and replaced with hydraulic linkages which are easier to plumb and not prone to debris issues. The various systems, apparatus, methods, and other constructs may include any suitable combination of the features disclosed herein, including one or more of the following statements.

Statement 1. A system comprising: a neutron generator tube; a gas replenisher; and a heat blanket applied to the neutron generator tube configured to insulate the gas replenisher.

Statement 2. The system of statement 1, wherein the heat blanket comprises an acrylic polymer-based elastomer.

Statement 3. The system of statement 2, wherein the acrylic polymer-based elastomer is cross-linked with mineral fillers to form a composite material.

Statement 4. The system of statement 3, wherein the mineral fillers are utilized to strengthen structural integrity of acrylic polymer-based elastomer.

Statement 5. The system of statement 3, wherein length, height, and width of the mineral fillers are 0.01 nm-0.1 nm, 0.1 nm-10 nm, 10 nm-100 nm, 100 nm-1 mm.

Statement 6. The system of statement 3, wherein the mineral fillers improve thermal conductivity, heat resistance, and thermal barrier capabilities of the acrylic polymer-based elastomer.

Statement 7. The system of statement 3, wherein cross linking the acrylic polymer-based elastomer with the mineral fillers comprises heating the acrylic polymer-based elastomer to above 300 degrees Fahrenheit for 15 to 60 minutes.

Statement 8. The system of statement 7, wherein cross linking the acrylic polymer-based elastomer with the mineral fillers further comprises adding stabilizers, wherein the stabilizers comprise Phenolic based, Amine based, Heterocyclic based, and Phosphite based stabilizer fillers.

Statement 9. The system of statement 7, wherein cross linking the acrylic polymer-based elastomer with the mineral fillers further comprises adding metal stearate, diamine and/or organic peroxide.

Statement 10. The system of statement 3, wherein cross linking the acrylic polymer-based elastomer with the mineral fillers yields a hardness of 30-95 of Shore A.

Statement 11. The system of statement 3, wherein the composite material is molded directly onto the neutron generator tube forming the heat blanket.

Statement 12. The system of statement 3, wherein mineral fillers comprise, Talc, Silicates, montmorillonite, calcium carbonate, kaolin, clay, or a combination thereof.

Statement 13. The system of statement 12, wherein dosage of the mineral fillers is between 100-300 parts per hundred rubber.

Statement 14. The system of statement 3, wherein the mineral fillers comprise a surface area to volume ratio of at least 1*10\hat{ }5 m²/m³.

Statement 15. A method comprising: disposing a neutron generator tube in a borehole, wherein the neutron generator tube comprises a gas replenisher; and applying a heat blanket to the neutron generator tube, wherein the heat blanket is configured to insulate the gas replenisher.

Statement 16. The method of statement 15, wherein the heat blanket comprises an acrylic polymer-based elastomer and the acrylic polymer-based elastomer is cross-linked with mineral fillers to form a composite material.

Statement 17. The method of statement 16, wherein cross linking the acrylic polymer-based elastomer with the mineral fillers further comprises adding metal stearate, diamine and/or organic peroxide.

Statement 18. The method of statement 16, wherein cross linking the acrylic polymer-based elastomer with the mineral fillers yields a hardness of 30-95 of Shore A.

Statement 19. The method of statement 16, further comprising molding the composite material directly onto the neutron generator tube forming the heat blanket.

Statement 20. The method of statement 17, wherein mineral fillers comprise, Talc, Silicates, montmorillonite, calcium carbonate, kaolin, clay, or a combination thereof and dosage of the mineral fillers is between 100-300 parts per hundred rubber.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A system comprising:
a neutron generator tube;
a gas replenisher; and
a heat blanket applied to the neutron generator tube configured to insulate the gas replenisher.

2. The system of claim 1, wherein the heat blanket comprises an acrylic polymer-based elastomer.

3. The system of claim 2, wherein the acrylic polymer-based elastomer is cross-linked with mineral fillers to form a composite material.

4. The system of claim 3, wherein the mineral fillers are utilized to strengthen structural integrity of acrylic polymer-based elastomer.

5. The system of claim 3, wherein length, height, and width of the mineral fillers are 0.01 nm-0.1 nm, 0.1 nm-10 nm, 10 nm-100 nm, 100 nm-1 mm.

6. The system of claim 3, wherein the mineral fillers improve thermal conductivity, heat resistance, and thermal barrier capabilities of the acrylic polymer-based elastomer.

7. The system of claim 3, wherein cross linking the acrylic polymer-based elastomer with the mineral fillers comprises heating the acrylic polymer-based elastomer to above 300 degrees Fahrenheit for 15 to 60 minutes.

8. The system of claim 7, wherein cross linking the acrylic polymer-based elastomer with the mineral fillers further comprises adding stabilizers, wherein the stabilizers comprise Phenolic based, Amine based, Heterocyclic based, and Phosphite based stabilizer fillers.

9. The system of claim 7, wherein cross linking the acrylic polymer-based elastomer with the mineral fillers further comprises adding metal stearate, diamine and/or organic peroxide.

10. The system of claim 3, wherein cross linking the acrylic polymer-based elastomer with the mineral fillers yields a hardness of 30-95 of Shore A.

11. The system of claim 3, wherein the composite material is molded directly onto the neutron generator tube forming the heat blanket.

12. The system of claim 3, wherein mineral fillers comprise, Talc, Silicates, montmorillonite, calcium carbonate, kaolin, clay, or a combination thereof.

13. The system of claim 12, wherein dosage of the mineral fillers is between 100-300 parts per hundred rubber.

14. The system of claim 3, wherein the mineral fillers comprise a surface area to volume ratio of at least 1*10\hat{ }5 m²/m³.

15. A method comprising:
disposing a neutron generator tube in a borehole, wherein the neutron generator tube comprises a gas replenisher; and
applying a heat blanket to the neutron generator tube, wherein the heat blanket is configured to insulate the gas replenisher.

16. The method of claim 15, wherein the heat blanket comprises an acrylic polymer-based elastomer and the acrylic polymer-based elastomer is cross-linked with mineral fillers to form a composite material.

17. The method of claim 16, wherein cross linking the acrylic polymer-based elastomer with the mineral fillers further comprises adding metal stearate, diamine and/or organic peroxide.

18. The method of claim 16, wherein cross linking the acrylic polymer-based elastomer with the mineral fillers yields a hardness of 30-95 of Shore A.

19. The method of claim 16, further comprising molding the composite material directly onto the neutron generator tube forming the heat blanket.

20. The method of claim 17. wherein mineral fillers comprise Talc, Silicates, montmorillonite. calcium carbonate, kaolin, clay, or a combination thereof and dosage of the mineral fillers is between 100-300 parts per hundred rubber.
